(19) United States
(12) Patent Application Publication
(10) Pub. No.: US 2006/0246406 A1
(43) Pub. Date: Nov. 2, 2006

(54) Tutorial and wits-increment auto-drive toy car

(76) Inventor: Hung-Peng Fu, Yonghe City (TW)

Correspondence Address: BIRCH STEWART KOLASCH & BIRCH, PO BOX 747, FALLS CHURCH, VA, 22040-0747, US

(21) Appl. No.: 11/104,432

(22) Filed: Apr. 13, 2005

(51) Int. Cl. G09B 23/18

(52) U.S. Cl. 434/301

(57) ABSTRACT

This invention is directed to a device of “a tutorial and wits-increment auto-drive toy car”, mainly consists of a functional board and a shell body, whereas multiple buttons set up on the functional board. Each electronic component has button-holes for assembling together on the functional board. In accordance with the electronic circuit layout and forming a control circuit to produce the function, which can be controlled by sound, light, infrared or wireless tool, and then leads the directions of the car.

### BACKGROUND OF THE INVENTION

I. Field of the Invention

The present invention is relates to “a tutorial and wits-increment auto-drive toy car”, more particularly to an auto-drive toy car from which learner can learn basic electronic control theory and knowledge, and have fun.

II. Description of the Prior Art

The major purpose of practical experiment is to lure the children in interesting the natural environment by noticing various kind of natural phenomenon, studying the natural issues, going down to bedrock, and gradually nurse the deductive science spirits; in general, to inspire students thinking of and resolving problems is better than to pour knowledge by lecture in the class. If the instructor in class spends a large portion of time in lecture, students will have less time to exercise practical experiment and could hardly get the whole concept of the lesson being taught. The conventional experiment material sometimes leads to a certain result, if exercise along with default procedures step by step.

Education is not only to teach student how to solve problems, but also to teach student how to find out potential issues by self-training. Tedious and uninteresting electronic circuit course in the electronic department of professional senior high school and ‘college cannot invite student’s interesting.

Decades ago, students have to buy electronic experiment materials such as transistors, capacitors, resistors, IC board, wire solder, etc. depends what kind of experiments, and wielding these components on the board according to the layout offered by the teacher. Nowadays many stores also sell various kind of finished works to meet students' course requirements, the students then get less opportunity to understand the relationship between those electronic components by saving self experiment time for personal affairs.

### SUMMARY OF THE INVENTION

It is therefore a primary object of the present invention to provide “a tutorial and wits-increment auto-drive toy car” by which the student interests can be promoted and increase the deductive ability.

In order to attain the above-mentioned tutorial object, the present invention primarily includes a functional board 1, electronic components, shell body, motor, and wheels. The functional board 1 has multiple buttons arranged in matrix type, while the electronic components fixed with button-hole opposite to the button of the functional board 1.

Accordingly, the present invention makes student mount or dismount electronic components (such as resistor, transistor, and capacitor, etc.) on the functional board 1 very conveniently without any welding. Furthermore, buckle sensor device and relative electronic components on the functional board 1 to form a function unit which can detect blockade before turning around, or replace sensor device by microphone to control the start and stop of the auto-drive toy car by sound wave, or replace microphone by light sensor to control the start and stop of auto-drive toy car by light, or control the auto-drive toy car by remote wireless control device. The students can reorganize the electronic components by altering original layout design to form a new control unit which can play different moving direction and action. The components mounted on the functional board 1 can be dismounted after the experiments for other experiment's usage. Students can then learn more experiments from the present invention.

### BRIEF DESCRIPTION OF THE DRAWINGS

The accomplishment of the above-mentioned object of the present invention will become apparent from the following description and its accompanying drawings which disclose illustrative and embodiment of the present invention, and are as follows:

FIG. 1 is a perspective view of the present invention

FIG. 2 is a perspective view of an assembled cardiogram.

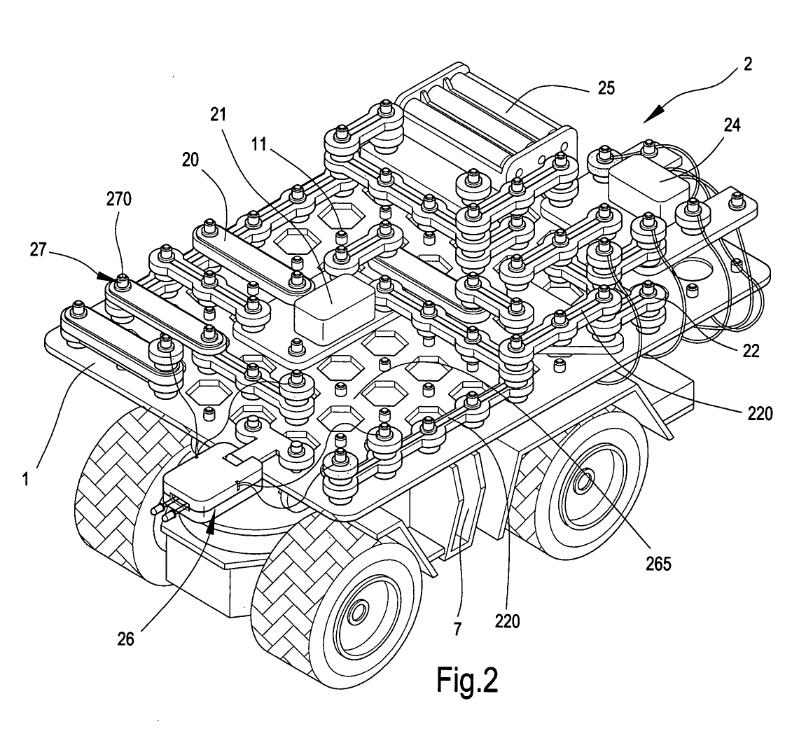

FIG. 3A is top plan view of the functional board of the present invention.

FIG. 3B is side plan view of the functional board of the present invention.

FIG. 4A, 4B is the assembly diagram of the electronic components of the present invention.

FIG. 5 is the perspective view of infrared emitter and receiver module

FIG. 6, 7 is the assembly circuit layout of electronic components of the present invention

### DETAILED DESCRIPTION OF THE PREFERRED EMBODIMENTS

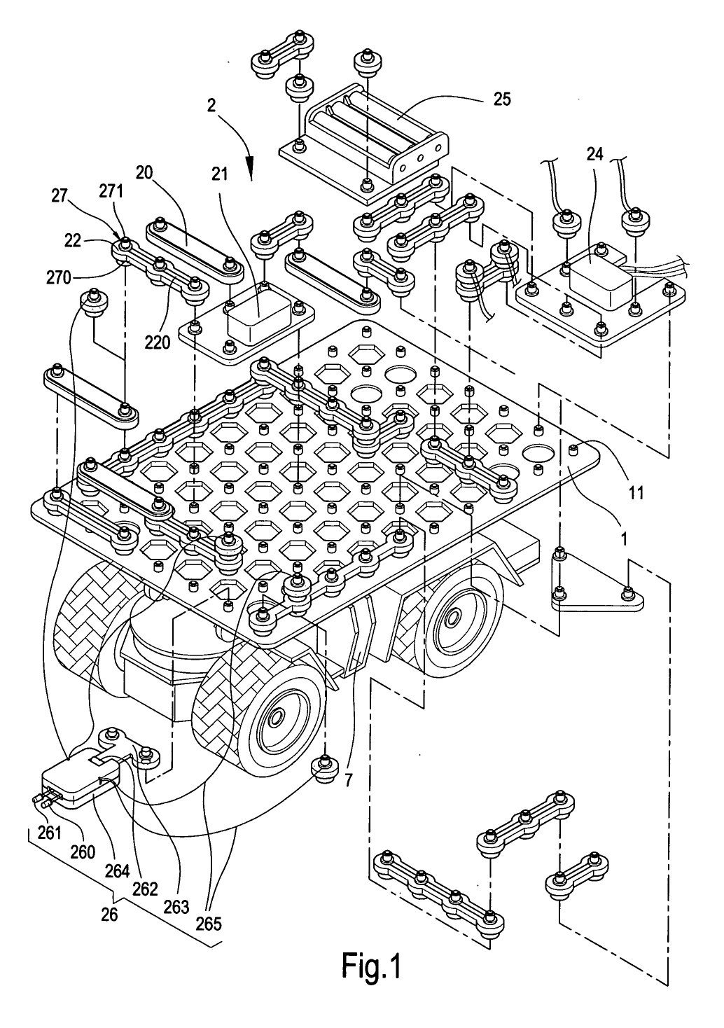

First all, referring to FIG. 1, 2, “the tutorial and wits-increment auto-drive toy car” in accordance with the present invention primarily includes shell body 7 and various kinds of electronic components 2, and characterized by:

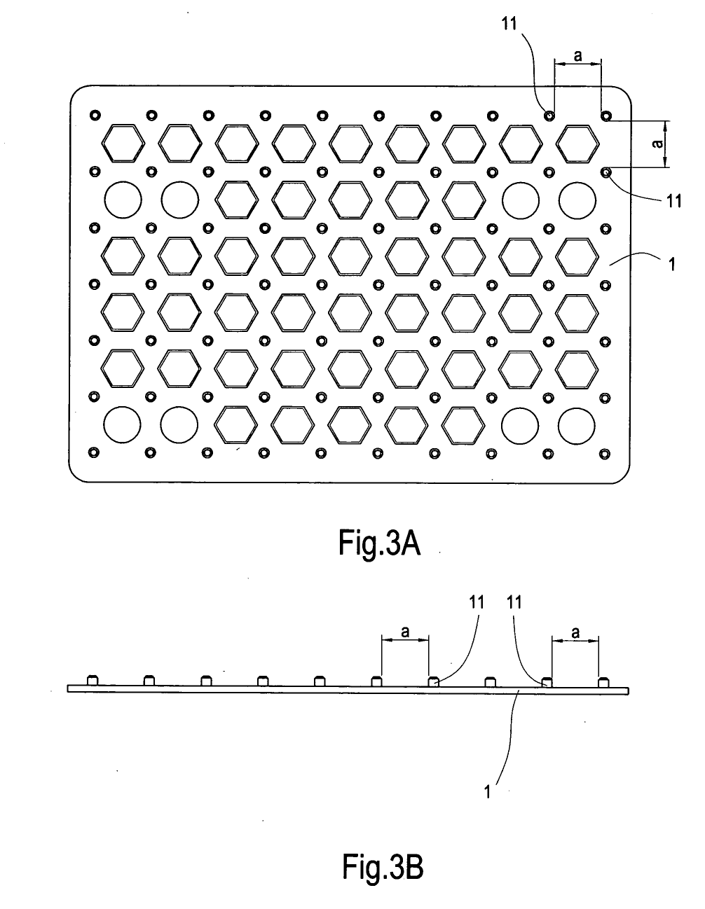

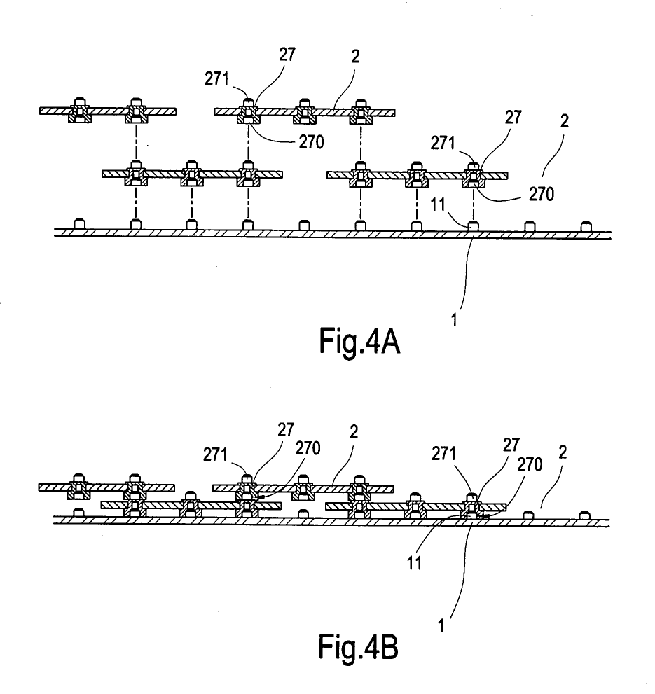

There are four wheels fixed at the bottom of the shell body 7, and one motor inside of the shell body 7 which is covered by a functional board 1 (please refer to FIG. 3A, 3B), with multiple buttons 11 scattered in matrix type and at same distance a between each other.

Electronic components 2, designed with button-hole 27 in appropriate position opposite to the button 11 of functional board 1 for buckle up, includes control module 21, adapter module 24, battery box 25, sensor device 26, remote control emitter, multiple resistor boards 20 and connection board 22. Several resistor values set up at each resistor board 20 with two button-holes 27 at both ends which has the same distance as that of two buttons 11.

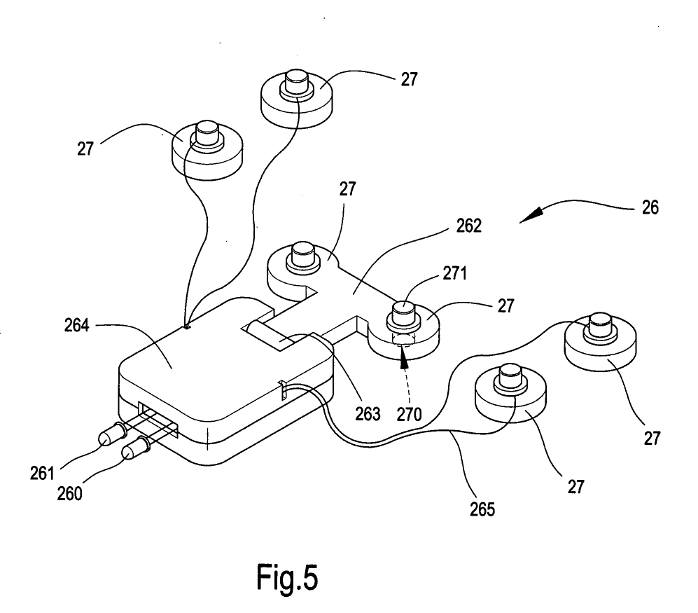

The button-hole 27 is made from conductive metal (please refer to FIG. 4A) with a groove 270 at lower part which opposite to the button 11 of functional board 1, and on top of the button-hole 27 is the button-like block 271 which is opposite to the button-hole of another electronic components for buckle up purpose;

Multiple connection boards 22 has different lengths, which must be the same or several times of the distance between two neighbor buttons 11 and with button-holes 27 opposite to'each button 11, the connection board 22 possess conductive cord 220 to connect all button-holes 27 into a series.

At the edge of control module 21, adapter module 24, and battery box 25 set up multiple button-holes 27 which is arranged to opposite the button 11 of functional board 1 for the purpose of fasten together.

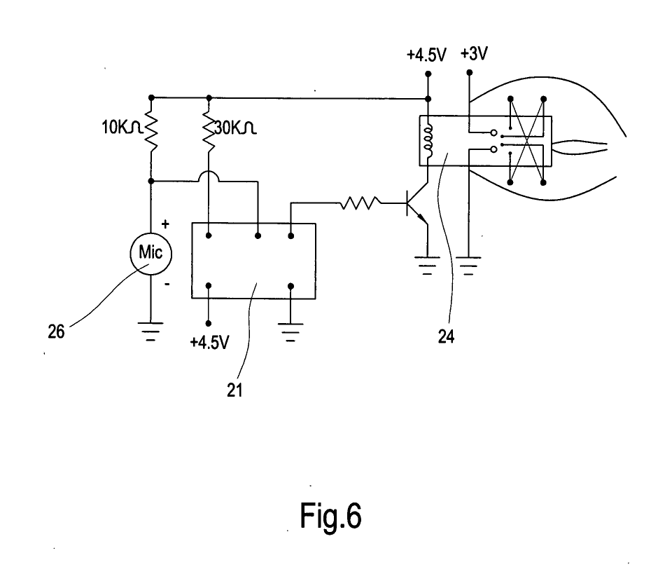

The sensor device 26 is a kind of infrared receiver and emitter module, at the end of the infrared receiver and emitter module fixed a T-bar 262 (Please refer to FIG. 5) which possesses two button-holes 27 at both ends of T head with the same distance as that of two neighbor buttons 11, at the other end of T-bar arranged a shaft 263 which is used to connect with box 264 that have infrared emitter 260 and infrared receiver 261 at head end, four power cords 265 with button-holes 27 at the other end connect to input and output pin of infrared receiver and emitter.

As shown above, please further refer to FIG. 4A, 4B, button 11 can be embedded into groove 270 to make button-hole 27 fix on the functional board 1; the button 271 top of button-hole 27 can be embedded into the groove 270 of another button-hole 27 so that any button-hole 27 could be buckle up with another button-hole 27, makes every electronic components could be fixed on the functional board 1 by means of the button-hole 27 and button 11 fasten together, and could also be stacked layer by layer, and make used of the conductive character of the metal cord.

Furthermore, the electronic components of the present invention are mounted and dismounted on the functional board 1 and the other electronic components by means of button-hole 27 and button 11, therefore the components can be combined, changed to another components or torn down fast by merely dismounted the components from where it is mounted by hand instead of the welding and prior circuit planning skill, then students used the present invention will find it is interesting, as easy as playing the building blocks, and be willing to do the experiments which will stimulate the student's creative, thinking, and scientific ability.

Please also refer to FIG. 5, the sensor device is used to detect the passing route, and if the infrared emitter and receiver module acted as sensor device, the module could be fixed and mounted on the functional board 1 by the two button-holes 27 of T-bar 262, and four power cords 265 connected to the infrared emitter and receiver at one end, and at the other end a button 27 which is buckled with other electronic components and can be change easily to adjust the auto-drive toy car.

Moreover, T-bar 262 of infrared emitter and receiver module connected with the box 264 by a shaft 263 which is used as axis to adjust upward and downward angle to detect the environment status for auto-drive toy car's driving reference, once the infrared emitter and receiver module fixed on the functional board 1.

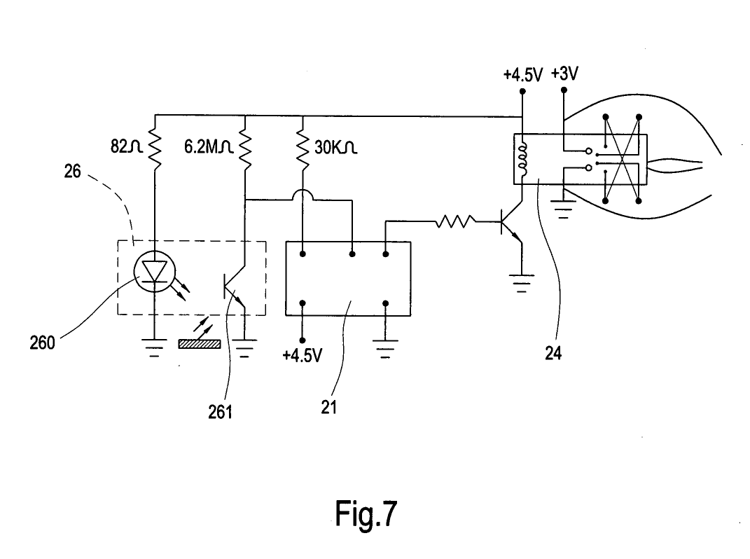

Additionally, the electronic components mounted on the functional board 1 can be set up according to the circuit layout of sound and light control, or infrared control (Please refer to FIG. 6, 7), consequently the above-mentioned infrared emitter and receiver module 26 can be changed by microphone or light sensitive resistor to match with the electronic components mounted so that the passing route of the auto-drive car can be controlled by sound or light.

In addition, the above-mentioned sensor device 26 can be altered into wireless control receiver, and controlled by a remote control to decide the passing route of auto-drive toy car.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claim.

What is claim is:

1. A tutorial and wits-increment auto-drive toy car at least comprising a shell body and various kind of electronic components, and characterized by:
four wheels set up at the bottom of the shell body with a motor inside, and on top of the shell body a functional board with multiple buttons on the surface; whereas electronic components in an adequate position have button-holes opposite to respective button for the purpose of buckle various kinds of electronic components on the functional board, then connect to motor with power cords in an unit to control the directions of the wheels.

2. The tutorial and wits-increment auto-drive toy car of claim 1, wherein the electronic components includes a control module, adaptor module, battery box, sensor device and wireless remote control emitter, and multiple resistor boards and connection boards.

3. The tutorial and wits-increment auto-drive toy car of claim 2, wherein senor device could be a microphone.

4. The tutorial and wits-increment auto-drive toy car of claim 2, wherein sensor device could be a light-sensitive resistor.

5. The tutorial and wits-increment auto-drive toy car of claim 2, wherein sensor device could be a wireless remote control.

6. The tutorial and wits-increment auto-drive toy car of claim 2, wherein sensor device could be an infrared emitter and receiver module.

7. The tutorial and wits-increment auto-drive toy car of claim 6, wherein at the end of the infrared emitter and receiver module set up a T-bar frame with above-mentioned button on the top of both ends with the same distance as that of two neighbor buttons; while at the other end of the T-bar fixed a shaft which is used to connected with the back end of the box, the front end of the box set up an infrared emitter and an infrared receiver which is respectively connected with a set of input and output power cord with button device at the other end.
